(19) United States
(12) Patent Application Publication
(10) Pub. No.: US 2012/0233765 A1
(43) Pub. Date: Sep. 20, 2012

(54) System and Method for Controlling the Environment of a Steambath

(76) Inventors: Mitchell Altman, Woodland Hills, CA (US); Scott Sharitz, Oxnard, CA (US); Paul Ulman, Woodland Hills, CA (US)

(21) Appl. No.: 13/438,621

(22) Filed: Apr. 3, 2012

Related U.S. Application Data
(63) Continuation-in-part of application No. 12/179,498, filed on Jul. 24, 2008, now abandoned.
(60) Provisional application No. 60/953,155, filed on Jul. 31, 2007.

(51) Int. Cl. A61H 33/06; G10L 15/00; G06F 3/041

(52) U.S. Cl. 4/524

(57) ABSTRACT

A steambath system is responsive to verbal commands to control the various aspects of the shower and steam environment such as water flow rate, water temperature, steam activation/de-activation, lighting intensity and/or color, music volume, music content, quantity and type of fragrance released, showerhead selection, radio activation, volume and station selection, television activation, volume and channel selection, DVD player activation and DVD selection, CD player activation and CD selection, and humidity control, and in a preferred embodiment utilizes radio frequency (RF) communication.

### INCORPORATION BY REFERENCE

This is a continuation-in-part of U.S. patent application Ser. No. 12/179,498, filed Jul. 24, 2008, and claims priority of Provisional Patent Application Ser. No. 60/1953,155 filed Jul. 31, 2007.

### BACKGROUND OF THE INVENTION

1. Field of the Invention

This invention relates to steambath systems and, more specifically, to steambath systems having apparatus capable of being controlled by an operator.

2. Description of the Prior Art

Steam showers have been known for many years. The operation of steam showers was first accomplished using manual switches and/or mechanical timers to control steam-generating units. The more advanced steam shower systems comprised manually controlled wire control units mounted inside the steam enclosure. These manual controls were capable of controlling the steam generating units and other accessories such as music, lights, telephone answering devices and other apparatus. Other systems have included wireless manually operable remote controls that are compatible feature-wise with the wired controlled units.

The controllability of the manually controllable wired and wireless systems is somewhat limited. For example, the user must be physically located in near proximity to the control unit in order to manually operate it. With respect to wireless control apparatus, a user may locate a manually operable remote control unit in a first location but from time to time be located in a second location. In the event of a desire to change the settings of the control unit, the user will thus be required to physically relocate to the first location so that he may manually adjust the remote control apparatus.

### SUMMARY OF THE INVENTION

The invention herein enables the user to control the steambath system (as well as desired accessories) using verbal commands. The invention is capable of interpreting the verbal commands and thus to control the various aspects of the shower and steam environment (hereinafter, “steam environment”).

As used herein, the term “steam environment” shall be used to refer to the controlled parameters of the steam room environment. Depending on the user's set-up, these can include, but are not limited to, water flow rate, water temperature, steam activation/de-activation, lighting intensity and/or color, music volume, music content, quantity and type of fragrance released (i.e., the fragrance choice and quantity of fragrance to be dispersed), showerhead selection (e.g., rain, waterfall, spray, massage; vertical message), radio activation, volume and station selection, television activation, volume and channel selection, DVD player activation and DVD selection, CD player activation and CD selection, and humidity control. Further, it is understood that the selection of a shower message may also include selection of the massage frequency and/or strength. Those skilled in this art will understand that these parameters are controlled by ancillary control units that are ultimately responsive to the voice command.

Apparatus for controlling the ancillary units comprises: microphone means capable of converting audio signals into electrical signals and having output means for transmission of the electrical signals; a voice recognition circuit having an input and an output, the input being operably connected to the microphone means output and the voice recognition circuit being capable of converting the transmitted electrical signals into digital output signals; a computer processing unit operably connected to the output of the voice recognition circuit for responsive controlling of at least one control unit, the computer processing unit having an output port for transmission of control signals for said purpose; a network having an input terminal and one or more output terminals, the input terminal operably connected to the output port of the computer processing unit; and one or more control units, each control unit operably connected to an output terminal of the network, each control unit capable of adjusting ancillary units; wherein the microphone is located to be in audio communication with the steam room and is capable of converting audio waves in the steam room into electrical signals.

In a preferred embodiment of the invention, the invention is capable of providing audio information to the user confirming system status as well as other information. In another preferred embodiment, the audio information comprises voice generated audio. In another embodiment of the invention, apparatus for communicating comprises radio frequency (RF) communication is provided.

An objective of the present invention is to promote the comfort, relaxation, and rest of the user, and specifically to provide a voice controllable steam bath system for the user, so that there is no requirement of moving locations to adjust the control unit.

Another objective of the invention is to provide a steambath system that is easy to operate, safe and manufacturable at a reasonable cost. Other objects and features of the invention will be appreciated by those having ordinary skill in the art from the figures and description set forth below.

Greater details of the invention will be given herein below in the following description of the preferred embodiment thereof of which the accompanying drawings form a part. Neither the description of the preferred embodiment nor the accompanying drawings are to be construed to limit the invention. Rather, the scope of this invention is intended to be limited only by the prior art.

### BRIEF DESCRIPTION OF THE DRAWINGS

FIG. 1 is a block diagram comprising a preferred embodiment of the invention in partial schematic form;

FIG. 2 is a block diagram illustration of the operational steps in a preferred system constructed in accordance with a preferred embodiment of the invention;

FIG. 3 is a schematic illustration of the microprocessor circuitry utilized in a preferred embodiment of the invention;

FIG. 4 in a block diagram comprising a second preferred embodiment of the invention in partial schematic form; and,

FIG. 5 in a block diagram comprising potential verbal commands recognizable by a preferred embodiment of the invention.

As will be appreciated, the Figures depict preferred embodiments of the invention in schematic form for the sake of clarity, and identify various features thereof. The figures are not necessarily to scale and are described in more detail below.

### DESCRIPTION OF THE PREFERRED EMBODIMENT

The present invention will now be described more fully herein after with reference to the accompanying drawings, in which a preferred embodiment of the invention is shown. The invention may, however, be embodied in many different forms and should not be construed as limited to the embodiments set forth herein; rather, these embodiments are provided so that this disclosure will be thorough and complete, and will fully convey the scope of the invention to those skilled in the art.

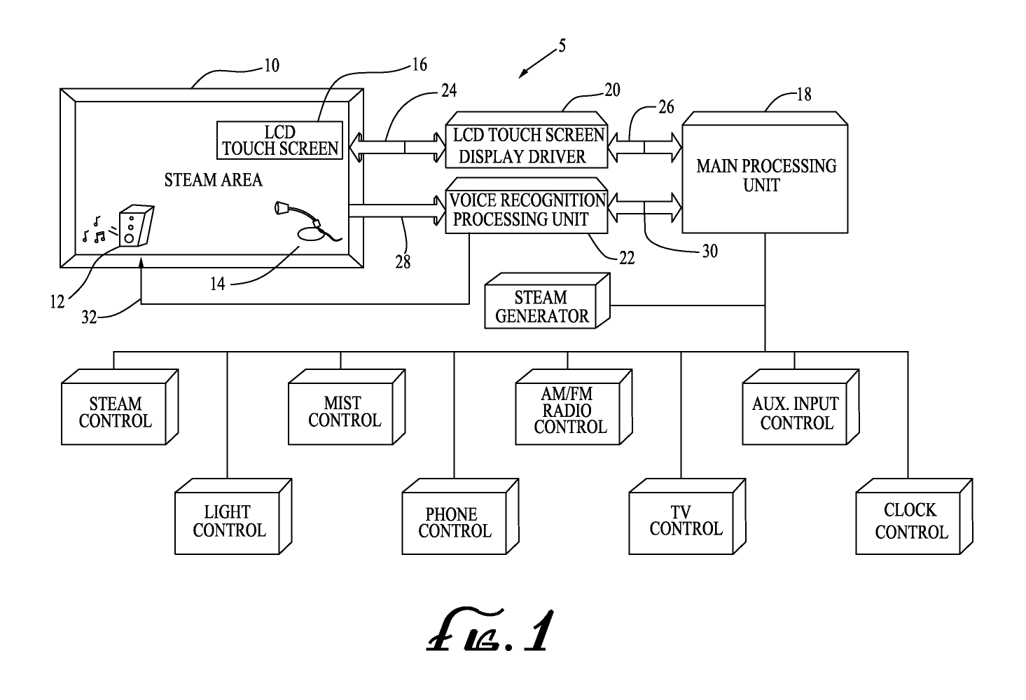

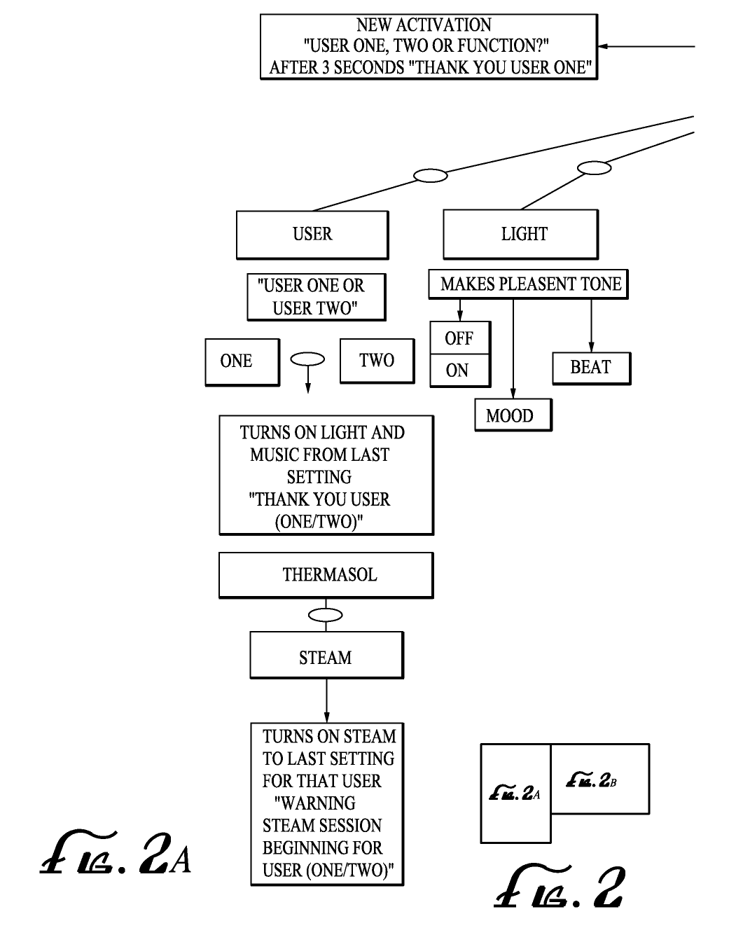

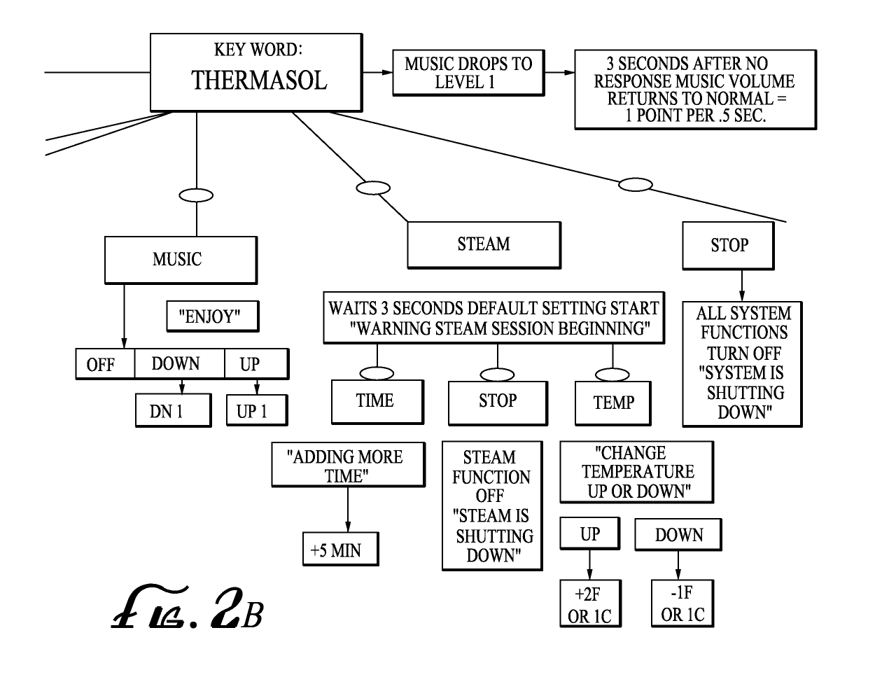

Referring initially to FIG. 1, there is depicted therein a shower/steam enclosure 10 having one or more speakers 12, a microphone 14 and an LCD touch screen apparatus 16. Also depicted in FIG. 1 are main processing unit 18, LCD touch screen display driver 20 and voice recognition processing unit 22. The LCD touch screen display driver 20 communicates with LCD touch screen 16 and main processing unit 18 by means of communication channels 24 and 26, respectively. The microphone 14 is in communication with voice recognition processing unit 22 by means of communication channel 28 and the voice recognition processing unit 22 is in two-way communication with main processing unit 18 by means of communication channel 30.

As will also be appreciated by those having ordinary skill in the art, two-way communication channel 24 permits LCD touch screen 16 and LCD touch screen display driver 20 to be in two-way communication. As will be appreciated, a user may enter commands at LCD touch screen 16 which will be communicated to LCD touch screen display driver 20. Conversely, information for video display transmitted by LCD touch screen display driver 20 may be communicated to LCD touch screen 16 by means of communication channel 24. Although an LCD touch screen is currently preferable, it should be recognized that other types of displays and input devices are within the scope of the invention.

As will further be appreciated to those having an ordinary skill in the art, two-way communication channel 24, two-way communication channel 26, two-way communication channel 22 and communication channel 28 may comprise a hardwired system or the radio frequency coupling or any other type of communication channel capable of carrying audio or digital information may be utilized.

As will be appreciated by those having an ordinary skill in the art, two-way communication channel 26 is capable of transferring information or commands between LCD touch screen display driver 20 and main processing unit 18. Two-way communication channel 22 is also capable of transferring audio or digital information between voice recognition processing unit 22 and main processing unit 18.

Audio information received by microphone 14 is transferred to voice recognition processing unit 22 by means of communication channel 28. Voice recognition processing unit 22 is capable of recognizing the appropriate audio input, converting the audio input to digital signals which are transferred over communication channel 30 to main processing unit 18 for processing. Voice recognition processing unit 22 communicates with speaker 12 by means of communication channel 32. Voice recognition processing unit 22 receives digital signals from main processing unit 18 which it is capable of decoding and encoding into audio signals which are transferred over communication channel 32 to speaker 12.

Thus, a user in the steam enclosure 10 is capable of issuing commands by means of the LCD touch screen 16 as well as audio commands by means of the microphone 14. Commands issued by means of the LCD touch screen 16 are transferred by means of communication channel 24 to the LCD touch screen display driver 20 which then processes the input from the LCD touch screen and converts it to an output recognizable by the main processing unit 18 and that output is communicated to the user by means of communication channel 26 to main processing unit 18. Similarly, main processing unit 18 is capable of providing information to the user by means of the generation of digital information over communication channel 26 to the LCD touch screen display driver 20 which then converts the signals and transmits them over communication channel 24 to LCD touch screen 16 which then displays the desired information. Similarly, the main processing unit 18 is capable of generating signals convertible into audio information which are communicated to the voice recognition processing unit 22 by means of communication channel 30. The voice recognition processing unit 22 processes such digital signals and converts the signals to appropriate signals transmitted over communication channel 32 to speaker 20 and such converted signals are converted by speaker 20 into audio information understandable by the user.

Thus, it will be appreciated that the user may provide digital input commands as well as audio commands into the system and the system is capable of communicating with the user by means of information displayed on the LCD touch screen 16 as well as audio information which is converted from electronic signals to audio by means of speaker 20 or any other type of electrical-audio transducer.

Another feature of the instant invention resides in the use of voice and/or keypad activated baffles to control the steam environment parameter of steam density. Because steambath “fog” actually dissipates as humidity approaches 100%, colder dryer air is controllably introduced into the environment to maintain the desired level of fog.

Additional voice and/or keypad activated features may include the following steam environment parameter controls:
timer settings to control steambath time and/or steambath phases,
telephonic communications, preferably Blue Tooth® cell phone communication,
paging service for service staff
soap/shampoo dispensing
entry control systems for communicating with, and selectively permitting entry of, visitors to the residence,
voice recognition circuitry that is responsive to specific user(s) whose tone and inflection is recognized, and which can use such recognition to address each such user by name, and to set customized default steambath parameters, and
circuitry which interacts with a master home computer system of the “smart house” type that controls activities and environment in the residence.

With regard to “smart house” systems, the invention herein includes a “smart house module” that can be connected between the “smart house” microprocessor and the steam generator of an existing steam bath system to make the resulting steam bath environment voice responsive without necessitating the replacement of its steam generator. In accordance with the invention, all communications and data may be transferred via a serial network or an analog data stream.

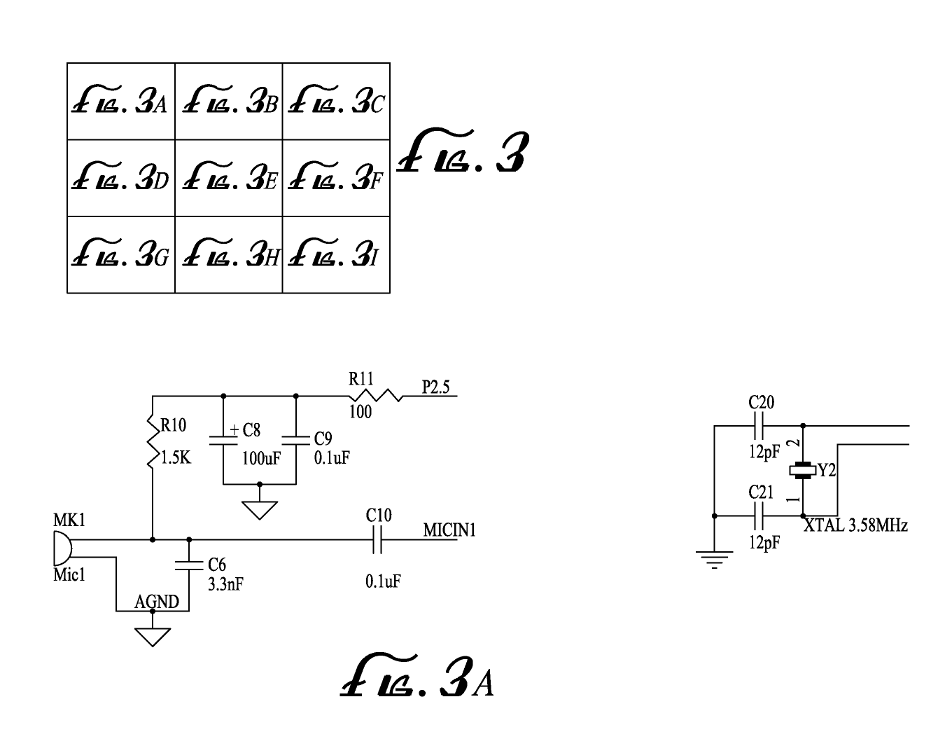

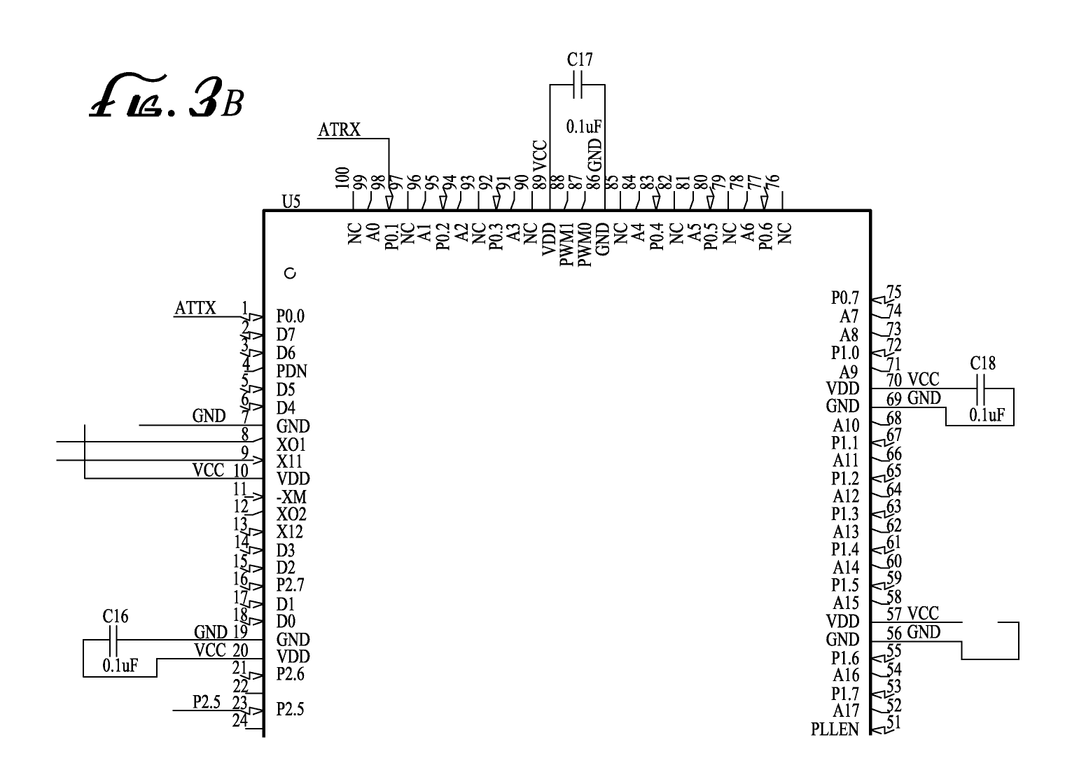

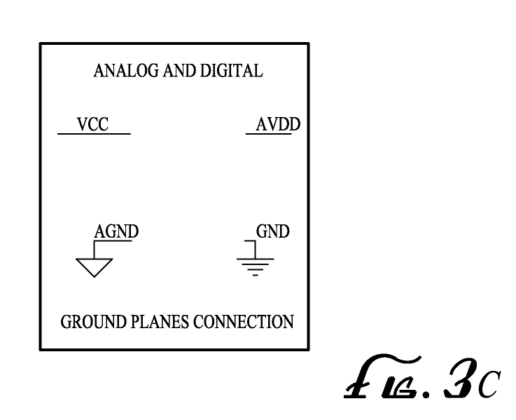

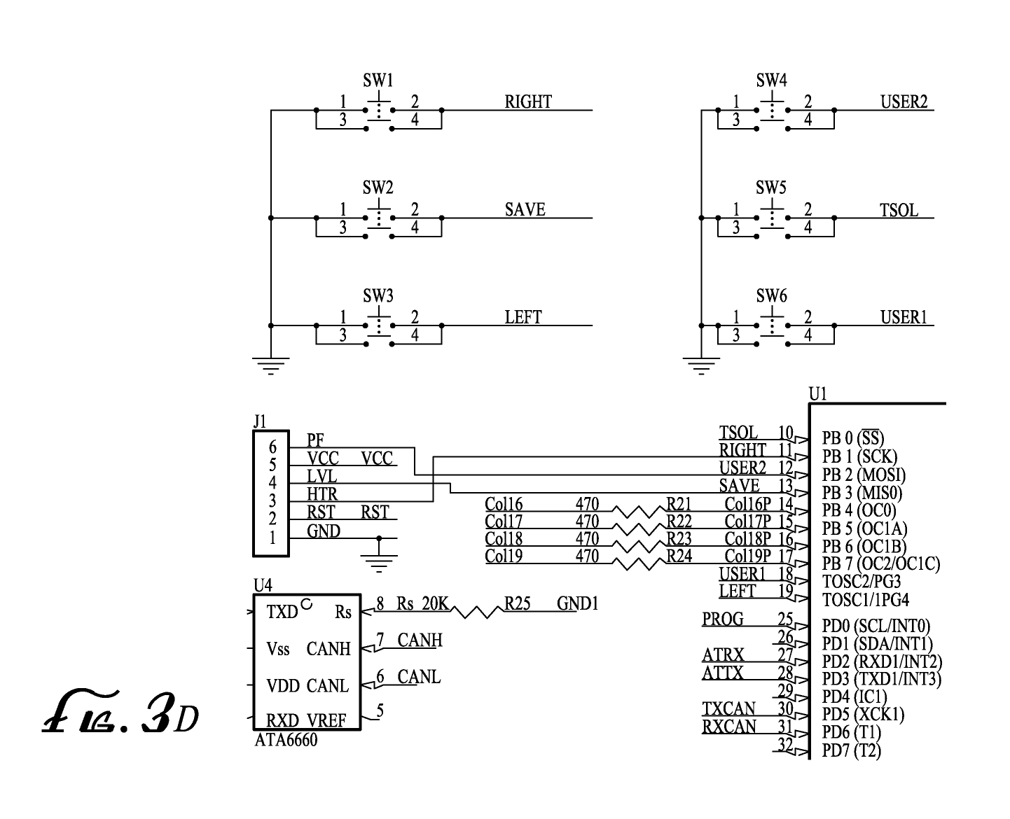

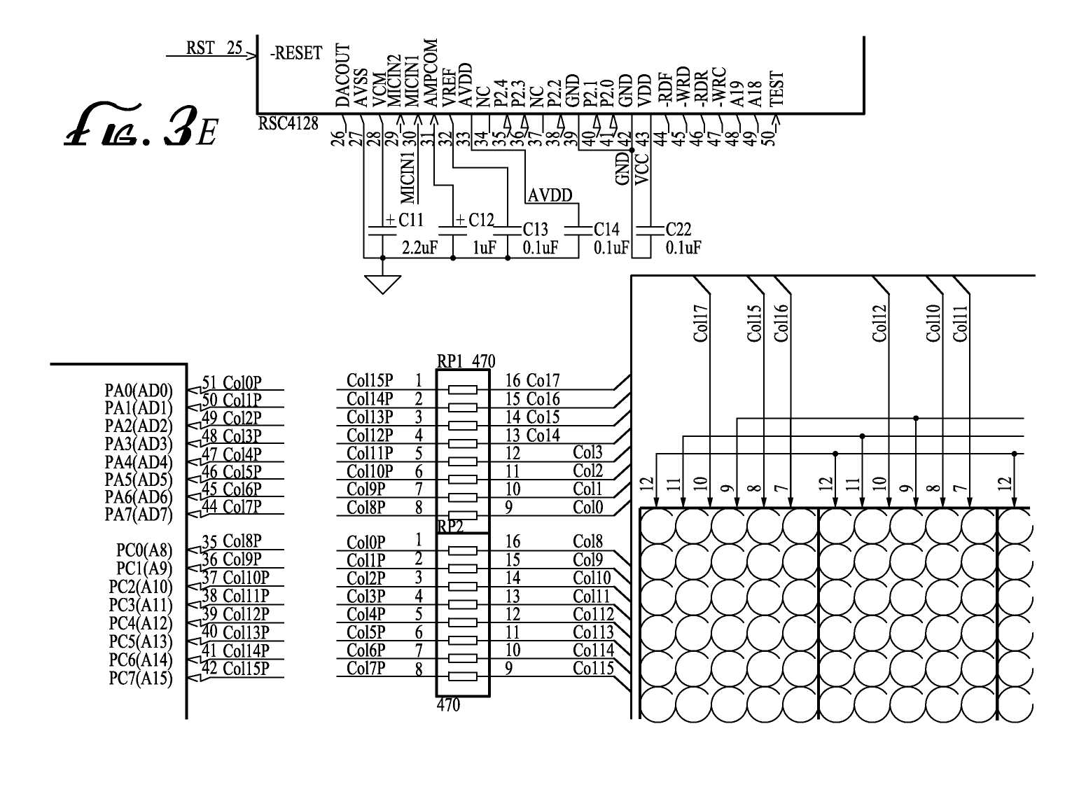

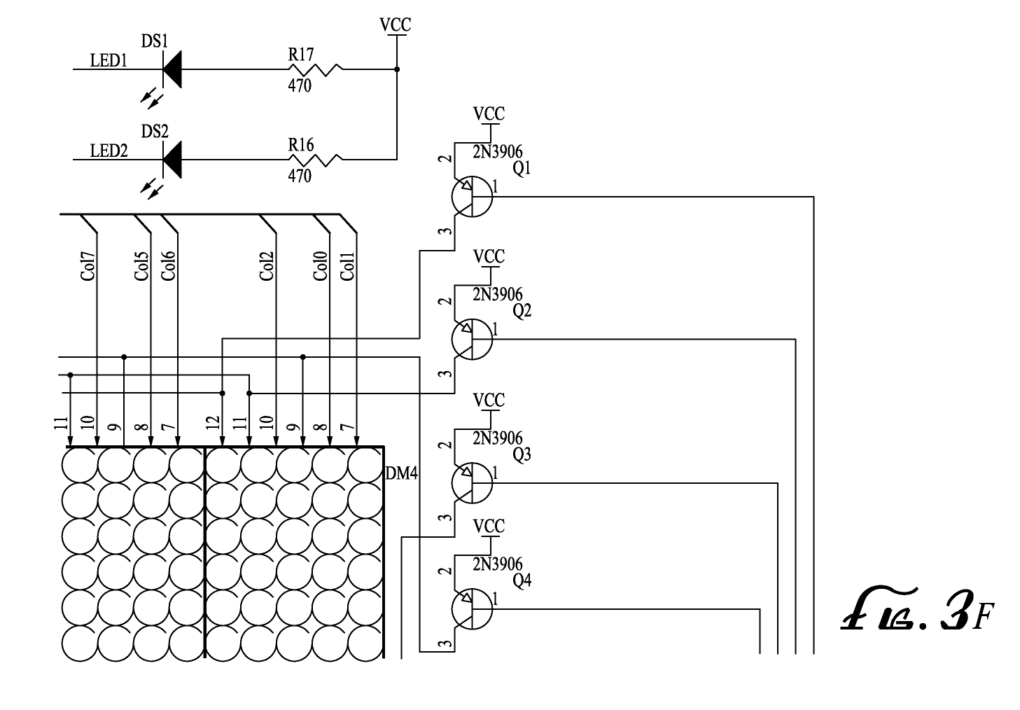

Turning to FIG. 2, a block diagram illustration is shown of the operational steps in a preferred system constructed in accordance with the invention. Voice controls are shown in bold font, with the system's verbal responses shown in light font. Naturally, both the commands and responses can be different without departing from the scope of the invention.

A user activates the system by saying a keyword that has been programmed into the system; e.g., “Thermasol”, followed by a command such as “user”, “light”, “music”, “steam”, or “stop”. The system responds as illustrated, with the user thereafter having the illustrated choices followed, if appropriate, by the illustrated further system response(s) and user-generated reply(ies).

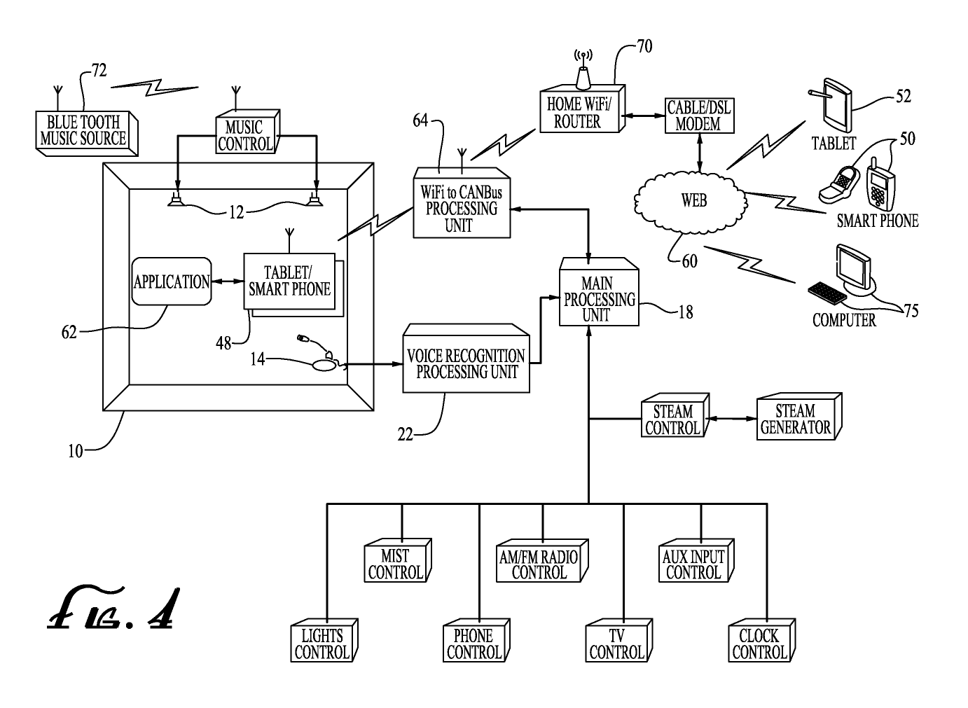

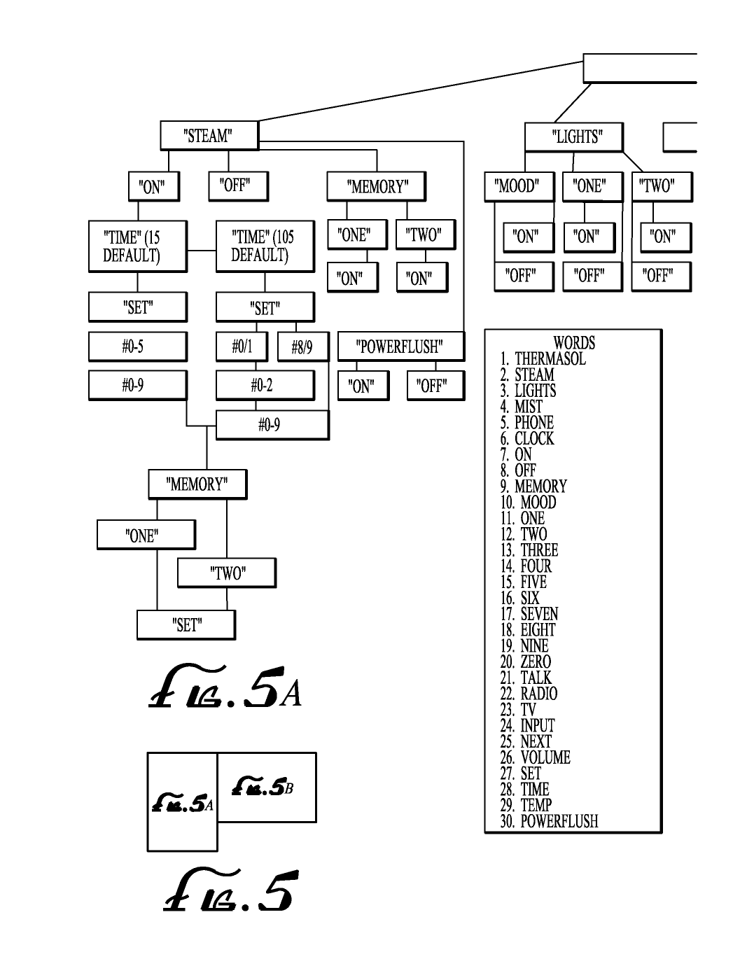

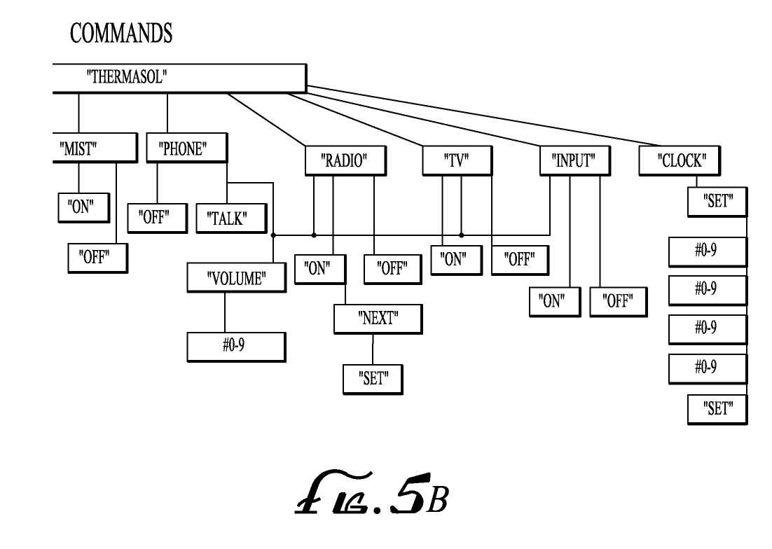

The potential verbal commands recognizable by the system are depicted in FIG. 5. It will be understood that a preferred embodiment of the invention need not be responsive to all of the verbal commands depicted in FIG. 5.

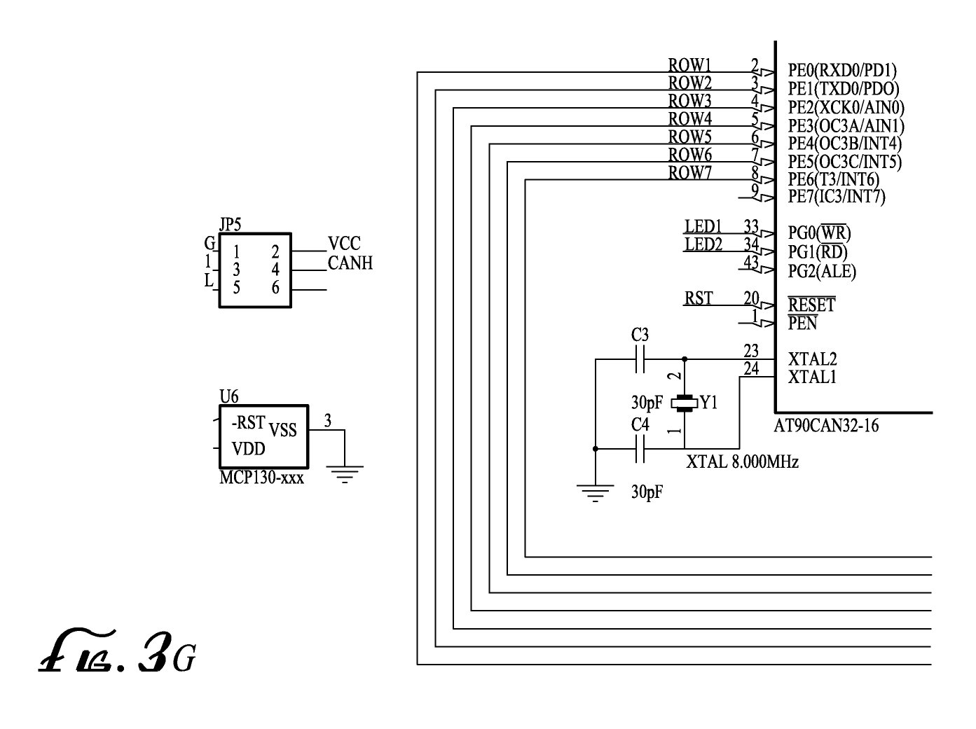

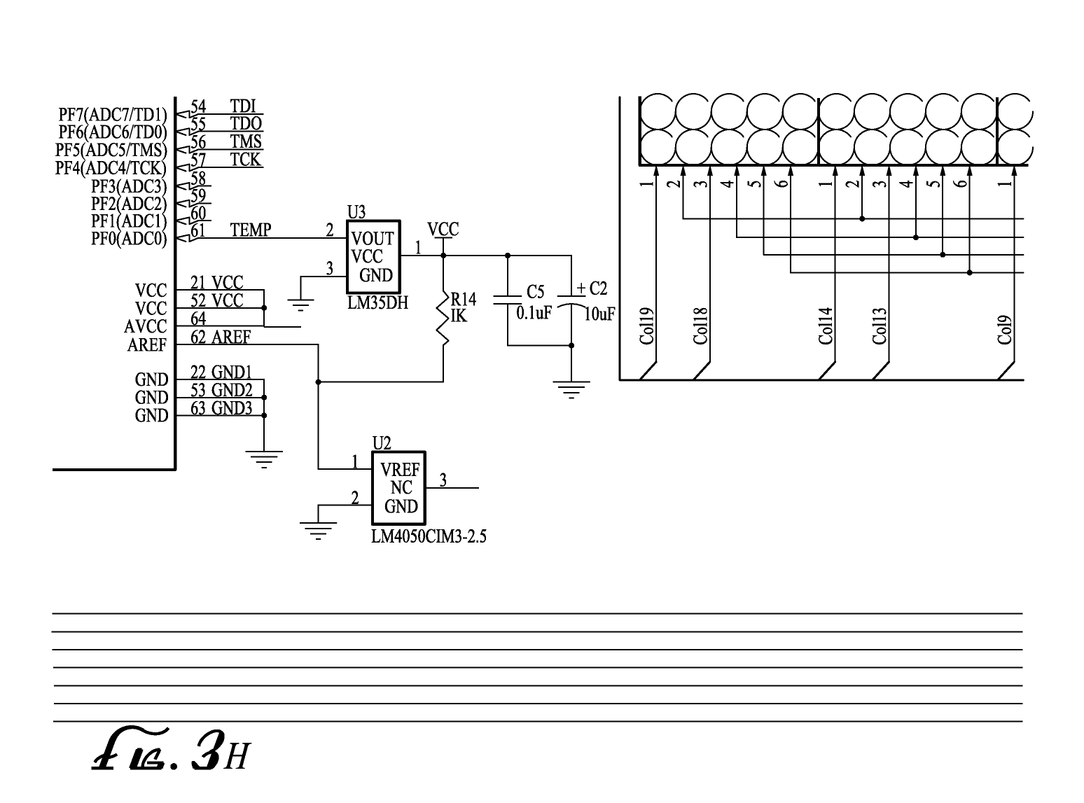

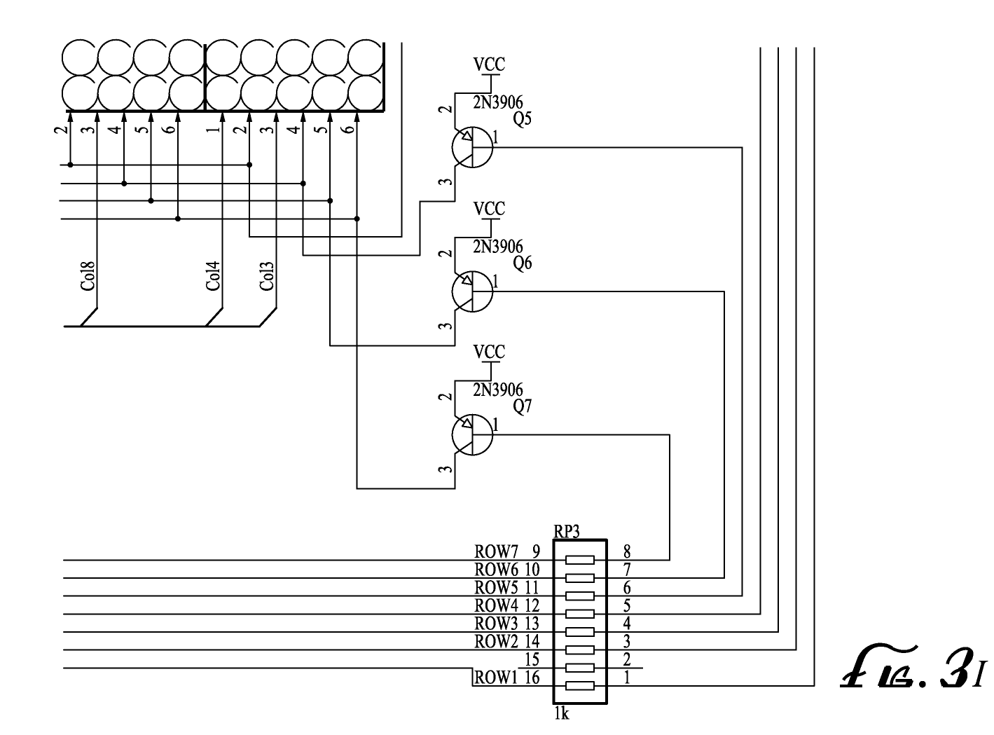

Referring now to FIG. 4 there is depicted a second preferred emobodiment of the invention.

Many wireless devices are presently available. Among those wireless devices 48 are smartphones 50, tablet computers 52, net books (not shown) and others. It will be understood by those having ordinary skill in the art that a smartphone is a cellular telephone with radio-frequency access to the World Wide Web and capable of running certain applications, data storage, email capability, and certain other functions. The common ground between all these devices is their capability for intercommunication locally at the user's house and globally over the cloud 60 of a world wide web. This intercommunication is a feature that usually is included in these devices. A software application 62 comprises all required user interface needed to allow the user to control the steam environment. The software application 62 is within the skill of those having ordinary skill in the art. It will be appreciated that use of a personal computer 75 Wi-Fi coupled or hard wired into the LAN (see below) or world wide web is also possible depending on the user's preferences and hardware.

A preferred embodiment of the invention comprises the steps of processing and converting the information over a wireless medium into the wired communication link that preferably connects all hardware peripherals. The processing and converting is preferably done locally. Once processed, each control device may be connected to the system by means of connectivity to the web. This communication is bidirectional so that the user may also receive online feedback from the system at any given time.

A preferred embodiment of the invention comprises a main processing unit 18 that receives commands from a voice recognition processing unit 22 and a Wi-Fi to CANBus processing unit 64. CANBus is understood by those having ordinary skill in the art as meaning a controller area network, which is a vehicle bus standard design to allow microcontrollers and devices to communicate with each other within a vehicle without a host computer. The Wi-Fi to CANBus processing unit 64 is known to and within the skill of those having ordinary skill in the art. The voice recognition unit 22 receives the user's commands and then filters and processes these to control all other sub-systems using specific communication channels. A Wi-Fi enabled device 48 such as a smartphone 50 or tablet computer 52 may be used inside or outside the shower area to control the steam environment based on user input on a touch screen, verbal commands or other input means.

The voice recognition control system uses electronic hardware microphone 14 and a voice recognition chip. Processing of these components and sensors is through the use of a standard microprocessor arranged on a PCB board and appropriate software known to those having ordinary skill in the art. All voice processing components may be located in the vicinity of the steam/shower room. Some of the electrical connections comprise connections among the microphone, temperature sensor, and other control lines that may be specified according to steam environment requirements.

The Wi-Fi to CANBus processing unit 64 is based on a microcontroller capable of running the CANBus protocol which in a preferred embodiment is a wireless Ethernet based 802.11 wireless protocol module. However, others having ordinary skill in the art will appreciate that other protocols may be used. The processing unit 64 comprises dedicated hardware and firmware that are written to control, convert and maintain constant secure and reliable communication between the Wi-Fi enabled user device 48 and the main processing unit 18. Reliable communication is preferably based on TCP/IP protocol.

There are at least two basic modes of operation of this preferred embodiment: A standalone mode and a home/local network based mode.

The standalone mode comprises a user supplied Wi-Fi enabled device 48 comprising a smartphone 50, tablet computer 52, netbook or other device with Wi-Fi capability and a Wi-Fi to CANBus processing unit 64. In this mode, the user is able to control the steam environment and get live steam environment feedback provided he is in range for reception of the Wi-Fi/Router 70.

The home local network mode comprises a user provided existing wireless local area network (LAN). In this mode, the Wi-Fi to CANBus processing unit 64 communicates with the user's existing network using the user's existing wireless security preferences. Depending on the particular configuration of such a system, the user would be able to control the steam environment from anywhere in the world by means of the world wide web.

Depending on the specific user Wi-Fi enabled device, special application software within the skill of one with ordinary skill in the art may be written specifically for or downloaded to the device. This application software allows the user to utilize the peripherals of his wireless touch screen device to graphically monitor and control system performance and settings. Some of these steam environment controllable functions comprise controlling and changing temperature and timer, controlling the music and light system, and other auxiliary outputs. The means for downloading the application from the internet is known by those having ordinary skill in the art and this adds flexibility to the invention and provides a means for future modifications.

The user has the ability to activate and deactivate (i.e: turn on and off) the system with all the possible controllable components including, but not limited to, steam, lights, mist, answer phone, AM/FM radio, CD/MP3 player, Blue Tooth wireless sources 72, TV, clock, and more. The user may also control the desired temperature and/or duration of steam operation, switch between pre-programmed memorized system settings, and operate the self cleaning (Powerflush) steam system. The user may control the volume of the speakers 12, fine tune the music equalizer, change radio stations, change tracks on the CD/MP3 player, configure the built in clock, etc. In addition, the user may activate external utility sources such as a fog free minor, external lights, towel warmers, radiant floor heating, etc.

The set of recognizable words comprises: Steam, Lights, Mist, Phone, Clock, On, Off, Memory, Mood, One, Two, Three, Four, Five, Six, Seven, Eight, Nine, Zero, Talk, Radio, TV, Input, Next, Volume, Set, Time, Temp, Powerflush. (See FIG. 5)

Although the present invention and its advantages have been described in detail, it should be understood that various changes, substitutions and alterations can be made herein without departing from the spirit and scope of the invention as defined by the appended claims.

I claim:

1. An apparatus for controlling the steam environment of an enclosure sufficiently sized to enclose a human user, comprising
a central processing unit having first input port means capable of processing an electrical signal corresponding to at least one audio command, second input port means capable of processing an electrical signal corresponding to at least one mechanically generated command, third input port means capable of processing a temperature indicative electrical signal corresponding to a temperature within the enclosure, and at least one output port means, the central processing unit being capable of generating an output command signal at said at least one output port means in response to at least one input signal at least one input port means;
first transducer means in operable communication with the first input port means of the central processing unit, and capable of generating a first electrical signal in response to an audio signal from within the enclosure;
second transducer means in operable communication with the second input port means of the central processing unit, and capable of generating a second electrical signal in response to a mechanically generated command by the user from within the enclosure;
a temperature sensor in operable communication with the third input port means of the central processing unit, and capable of generating an electrical signal responsive to the temperature within the enclosure; and
a steam generator in operable communication with at least one output port means of the central processing unit, and having an output vent for releasing steam under control of an output command signal generated by the central processing unit.

2. The apparatus of claim 1 wherein the first transducer means is a microphone.

3. The apparatus of claim 1 wherein the second transducer means is a touch screen.

4. The apparatus of claim 1 including voice recognition circuitry for digitizing said first electrical signal, and
means responsive to said digitized first electrical signal to generate a corresponding output command.

5. The apparatus of claim 1 including:
at least one control unit responsive to at least one output command signal from the central processing unit to vary at least one parameter of the steam environment;
voice recognition circuit means having an input and an output, the input being operably connected to the first transducer means to convert audio signals corresponding to at least some spoken words into respective digital output signals;
said central processing unit being operably connected to the output of the voice recognition circuit means for responsive controlling of said at least one control unit,

6. The apparatus of claim 5 including a network having an input terminal means and one or more output terminal means, the input terminal means being operably connected to an output port means of the central processing unit;
said at least one control unit being operably connected to a respective output terminal of the network, each control unit being capable of adjusting a respective parameter of the steam environment.

7. The apparatus of claim 6 including means within the central processing unit for providing audio information to the user concerning at least one user-generated command entered at least one of the first and second transducer means.

8. For use with a shower/steam enclosure, a system for use by a human user to control the steam environment within the enclosure and comprising:
speaker means for accepting verbal user-generated commands pertaining to the steam environment;
a touch screen display apparatus for accepting user commands entered by the user and pertaining to the steam environment;
a touch screen display driver configured for two-way communication with the touch screen, said touch screen being configured to communicate said commands to the touch screen driver and to display images communicated to it by the touch screen driver;
a voice processing unit in two-way communication configuration with said speaker means for processing said verbal user-generated commands; and
a main processing unit in communication with said speaker means, touch screen driver and voice recognition unit to generate control signals in response to user-generated commands for controlling the steam environment, said main processing unit being adapted to communicate said control signals to at least one steam-environment parameter controlling actuator.

9. The system of claim 8 including
first communication channel means linking the touch screen display driver and the touch screen so that information pertaining to displayed images is transferred to the touch screen.

10. The system of claim 9 wherein said first communication means links the touch screen display driver and the touch screen so that information pertaining to user-entered commands at the touch screen is transferred to the touch screen display driver.

11. The system of claim 9 wherein the first communication means includes a hard-wired communication channel.

12. The system of claim 11 wherein the first communication means utilizes radio-frequency coupling to transfer the information.

13. The system of claim 9 wherein the first communication means utilizes radio-frequency coupling to transfer the information.

14. The system of claim 8 including second communication channel means linking the speaker means with the voice processing unit so that information pertaining to verbal user-generated commands images is transferred to main processing unit.

15. The system of claim 14 wherein said second communication means links the speaker means with the voice processing unit so that information pertaining to user-entered commands is transferred to the speaker means from the central processing unit for verbal communication to the user.

16. The system of claim 14 wherein the second communication means includes a hard-wired communication channel.

17. The system of claim 16 wherein the second communication means utilizes radio-frequency coupling to transfer the information.

18. The system of claim 14 wherein the second communication means utilizes radio-frequency coupling to transfer the information.

19. An apparatus for controlling the steam environment of an enclosure sufficiently sized to enclose a human user, comprising
a central processing unit having first input port means capable of processing an electrical signal corresponding to at least one audio command, second input port means capable of processing an electrical signal corresponding to at least one mechanically generated command, third input port means capable of processing a temperature indicative electrical signal corresponding to a temperature within the enclosure, and at least one output port means, fourth input port means capable of processing an electrical signal corresponding to at least one user initiated radio frequency signal; the central processing unit being capable of generating an output command signal at said at least one output port means in response to at least one input signal at least one input port means;
first transducer means in operable communication with the first input port means of the central processing unit, and capable of generating a first electrical signal in response to an audio signal;
second transducer means in operable communication with the second input port means of the central processing unit, and capable of generating a second electrical signal in response to a mechanically generated command by the user from within the enclosure;
a temperature sensor in operable communication with the third input port means of the central processing unit, and capable of generating an electrical signal responsive to the temperature within the enclosure;
a steam generator in operable communication with at least one output port means of the central processing unit, and having an output vent for releasing steam under control of an output command signal generated by the central processing unit; and,
a radio-frequency to controller area network converter having a first port means in operable communication with the fourth input port means of the control processing unit,

20. The apparatus of claim 19, wherein the radio-frequency to controller area network converter comprises a Wi-Fi to CANBus processing unit.
